(19) United States
(12) Patent Application Publication
(10) Pub. No.: US 2005/0289037 A1
(43) Pub. Date: Dec. 29, 2005

(54) Financial asset product and method for implementing same

(76) Inventors: Joseph B. Smith, Pittsburgh, PA (US); Ben E. Benack, Pittsburgh, PA (US); Stephen C. Hansen, Pittsburgh, PA (US)

Correspondence Address: Barry I. Friedman, Esq.;Metz Lewis LLC, 18th Floor, 11 Stanwix Street, Pittsburgh, PA, 15222, US

(21) Appl. No.: 10/868,372

(22) Filed: Jun. 15, 2004

(51) Int. Cl. G06F 17/60

(52) U.S. Cl. 705/36

(57) ABSTRACT

The present invention relates to a financial asset product and a method for creation thereof, including a plurality of component instruments and a link among the components that interrelates the components as a unitary portfolio. The terms or other parameters of the components are arranged according to a preset plan of the depositor/investor. The method may include the steps of assessing the financial needs or goals of the depositor or investor, developing a predetermined or preset plan or strategy for the purchase, management, maintenance, sale, withdrawal and/or exchange of financial instruments. The instruments may be acquired at one time or over a period of time, also according to a preset plan.

### FIELD OF THE INVENTION

The present invention relates to a financial asset product and a method for implementing such a financial product in a portfolio having a plurality of component linked instruments and/or deposit products which are purchased, monitored, sold, reported, withdrawn and/or exchanged according to a predetermined strategy or plan. More particularly, the present invention relates to financial products that implement and automatically manage the portfolio by maintaining a purchase, maintenance and sale strategy with the multiple linked components. The financial asset components can include financial deposit products, such as bank certificates of deposit and bank checking and savings accounts, as well as fixed term investment products, such as bonds. A method for implementing and automatically managing such a portfolio according to such a strategy is also disclosed.

### BACKGROUND AND DESCRIPTION OF THE PRIOR ART

Customers in today's financial markets are faced with a blinding array of products and services. Furthermore, each financial product entails a series of parameters relating to rate of return, relative level of risk, liquidity, marketability and the like. Many products are specifically designed to provide predictable performance levels according to a specific parameter, such as maximizing rate of return. Typically, such a focus on a single parameter comes with a compromise in other aspects of the product, such as marketability or volatility of return. Other products have therefore been developed to appeal to investors wanting a broader or more balanced approach, such as mutual funds, which combine a group of subsidiary products into a single product, the performance of which is an aggregate of the performance of the components. This component approach may be utilized to balance competing aspects of the subsidiary products or to enhance only certain parameters of performance, at the expense of other parameters.

In many instances, the convenience of the investor drives the need to combine component elements into a single product. Utilizing the example of mutual funds, an investor could individually purchase the component equities which make up a particular fund according to a plan or strategy. Ignoring the management aspect of fund administration, the investor could independently track the performance of each component and record that information as aggregate data. More convenient, however, is: (a) the purchase of a mutual fund holding those component equities which provides both aggregate reporting of performance in a single parameter, being the purchase value of that fund and (b) the management feature of each fund.

This component approach has been applied in a number of financial fields outside of the equity and mutual fund markets. In many instances, the components are selected to either reduce the risk of negative performance or accelerate the returns in the event of positive performance. Examples of these types of these component approaches can be found in both the deposit or bond arena; typically involving banking, commercial or governmental institutions where a guaranteed return floor is established; and the investment field, where invested funds are entirely at risk. Limitations to an ad hoc approach of an individual attempting to implement a plan for a component investment include understanding the effect of combining or blending the component instruments, comparing various alternating combinations of component instruments and then tracking the disparate information associated with the components and performance against the plan. This is illustrated below.

One example of the component approach utilizes bank certificates of deposit. A bank certificate of deposit, also known as a CD, is a bank account that earns interest on the principal that is placed with the bank for a specified time period known as the term. A CD is similar to a loan, except that the depositor is loaning money to the bank and the bank pays the depositor interest at a rate that is guaranteed according to the deposit account contract. Federal Banking Regulation DD, or Truth in Savings, requires conversion of such interest rates by use of a prescribed formula to an Annual Percentage Yield (APY) for purposes of advertising and disclosures. CDs typically have terms ranging anywhere from one month to five or more years in which the depositor agrees to give the bank his or her money, the principal, for the term in return for interest paid to the depositor on the principal. If the depositor withdraws the principal before the term expires, that is before the CD matures, there is typically a penalty assessed against the depositor equal to, for example, some percentage of the principal or some specified amount of interest. Any potential penalties are disclosed to the depositor during the account opening process.

When a CD is about to mature, the bank sends the depositor a document known as a maturity notice. The maturity notice includes, among other things, the account number, term, maturity date and maturity value for the CD and terms that define a customer's options at maturity. Typically, these terms include a notice that, unless the depositor instructs the bank otherwise within a specified time period, the bank will automatically renew the CD for the same term (or some other previously disclosed term) at the APY in effect on the maturity date. In other words, if the depositor does nothing upon receiving a maturity notice, the CD will be automatically renewed for a term equal to the original term at the current APY as of the maturity date. Thus, if, for example, a depositor holds a $5,000 CD having a one year term and an APY of 1.5%, and if the depositor elects to leave the money with the bank upon receiving a maturity notice for the CD, then the CD will be renewed into another $5,000 CD having a one year term and an APY that is in effect on the maturity date. With respect to the interest earned during the term ($75 in this example), whether that interest is paid to the depositor or is re-deposited as part of the renewal processing is based on contractual terms. If the depositor wishes to get principal back, add additional principal, or acquire a CD having a different, i.e., longer or shorter, term, the depositor must take some affirmative action to do so, including contacting the bank and giving the bank instructions regarding how to deal with the maturing CD. This activity is also analogous to circumstances surrounding the purchase and maturity of any fixed term asset, such as a bond.

One common practice that exists with currently available CDs and other types of bank or depository accounts that form a part of a customer's predetermined strategy is that each CD or account is treated by the issuing bank as a separate account that is not linked with or to any other CDs or accounts of the depositor, even though to the depositor the multiple accounts may be part of a plan or strategy. Thus, when information relating to each CD is reported to the depositor, such as in a maturity notice, the information relates only to the particular CD in question and not to any other CDs or accounts of the depositor, even if, as described below, the CD in question and one or more of the depositor's other CDs or accounts form a portfolio of the depositor that implements a strategy of the depositor. Because multiple CDs in such a portfolio are not linked to one another, the issuing institution's computer based tracking, monitoring and reporting systems are not aware of the fact that the CDs or other accounts are being used to implement a particular strategy and thus the bank is not able to provide information to the depositor relating to the other CDs or the portfolio as a whole that would be helpful to the depositor in maintaining or making planning decisions relating to the portfolio and the strategy it implements. It should be noted, however, that statements or other reports which contain data from or relating to multiple accounts are well known in the banking and investment fields. These statements or reports are limited, however, in that they comprise mere lists of account or other information and do not reflect any specific strategies or combinations of data that the customer may be implementing which contain some or all of the assets reflected in the statement or report.

Moreover, most people, when considering whether to purchase or renew a CD, are faced with difficult decisions regarding the liquidity and term of non-liquidity associated with such a purchase. People must examine and weigh the risks and rewards associated with short versus long term investing, as well as consider their personal needs for funds on a timely basis, when deciding whether to purchase or renew a CD. Since longer term CDs put the customer's access to funds for purchases or emergencies out of reach, and typically offer higher returns, i.e., higher APYs, than shorter term CDs, the immediate reward is greater with longer term CDs. However, longer term CDs also carry a risk associated with the future direction of interest rates. Specifically, if a depositor invests long and then rates go up, the depositor will be locked into returns that are below market for much of the term of the CD, with no liquidity for reinvesting at the now higher rates. Also, there is a risk in longer term CDs associated with having all of a depositor's money tied-up should the depositor need to access the money for some unforeseen reason. On the other hand, shorter term CDs provide more liquidity as principal becomes available after shorter periods, but returns are typically lower than are available for longer term CDs. If rates do not move up over time or if rates move down, the depositors will have sacrificed interest that would have been earned through investing in longer terms.

CDs are issued in a variety of forms beyond the traditional fixed term, fixed interest rate embodiment. Other embodiments include variable rate CDs, having rates tied to certain economic indices or market rates. Other embodiments include limited options to sell and repurchase the CD at a more advantageous rate during the fixed term. Common features of all CDs and other fixed term assets include a fixed maturity date and a guaranteed positive return on the associated funds when held to maturity.

One commonly known strategy for managing and, to an extent, eliminating these risks is known as laddering. Laddering involves building a portfolio of fixed term instruments such as CDs or bonds with staggered maturities (i.e., short, intermediate and long term) so that a portion of the portfolio will mature periodically. Laddering, by staggering maturities, draws upon the concept of dollar cost averaging and improves returns without sacrificing safety while at the same time keeping part of the depositor's funds liquid. Laddering involves purchasing multiple CDs or other fixed term instruments, either at one time or over time. For example, one could purchase a two year CD every 6 months for a two year period. Alternatively, one could simultaneously purchase CDs of 6, 12, 18 and 24 months. Each CD constitutes a “rung” on the “ladder” that represents the total deposit.

Typically, in a laddering strategy that is constructed at one time, the maturities of the CDs that are purchased are staggered, so that a portion of the total amount deposited will mature at a fixed liquidity period X, e.g., every 3 months, every 6 months, or every 12 months. In other words, the liquidity period X is how often the depositor wants to have a portion of the total amount deposited be available. To implement the strategy, the depositor then purchases Y CDs, where Y is the number of “rungs” in the “ladder,” having terms equal to X, 2X, 3X . . . YX. The number of CDs Y is in part driven by the amount of principal that the depositor wants to have available at each liquidity period X, and thus may be chosen by dividing the total amount to be deposited by the amount of principal that the depositor wants to have available at each liquidity period X. It may also be based on the depositors preference for the longest maturity term he or she wants as part of the laddered portfolio. The amount that comes due at each liquidity period X is known as the liquidity amount, which is not necessarily equivalent in each period. Then, to maintain the strategy, as each CD in the portfolio matures and the principal becomes available, the depositor buys another CD having a term equal to YX.

An example of this laddering strategy is shown in Table 1 below in which the depositor has $30,000 to deposit and wants to have a portion of the money available every year, i.e., the liquidity period X is equal to one year. In addition, the depositor wants the portion to be available, the liquidity amount, to be equal to $6,000, and thus the number of CDs purchased, Y, is equal to $30,000 divided by $6,000, or five. To implement the strategy, the depositor buys five CDs having the terms shown in Table 1.

TABLE 1

| | | | Time Left | | |
|---|---|---|---|---|---|
| | | | Until | | |
| CD # | Principal | Term | Maturity | Rate | APY |
| 1 | $6,000 | 1 year | 1 year | 1.5% | 1.5% |
| 2 | $6,000 | 2 years | 2 years | 2% | 2% |
| 3 | $6,000 | 3 years | 3 years | 3% | 3% |
| 4 | $6,000 | 4 years | 4 years | 3.5% | 3.5% |
| 5 | $6,000 | 5 years | 5 years | 4% | 4% |

As will be appreciated, during the first year under this strategy, the depositor will be getting a current period blended rate of 2.8%, which is calculated as the weighted average of the rates of each individual CD in the portfolio. In addition, the depositor has $6,000 coming available in one year.

Next, according to the strategy, when CD #1 matures, i.e., at the end of the first year, it is renewed into a new $6,000 CD that has a term equal to five years (Note: For this example, it is assumed that accrued interest is not redeposited). In this example, the new CD #1 has an APY of 4% which is assumed to be the APY for a five year CD in effect at the time of maturity of CD #1. Table 2 shows the depositor's portfolio after this step.

TABLE 2

| | | | Time Left | | |
|---|---|---|---|---|---|
| | | | Until | | |
| CD # | Principal | Term | Maturity | Rate | APY |
| 2 | $6,000 | 2 years | 1 year | 2% | 2% |
| 3 | $6,000 | 3 years | 2 years | 3% | 3% |
| 4 | $6,000 | 4 years | 3 years | 3.5% | 3.5% |
| 5 | $6,000 | 5 years | 4 years | 4% | 4% |
| 1 | $6,000 | 5 years | 5 years | 4% | 4% |

Now, the depositor is getting a current period blended rate of 3.3% for the second year of the strategy and still has $6,000 coming available at the end of the second year.

As described above, according to the strategy, as each CD matures, it is renewed into another five year $6,000 CD at the then current APY, assumed to be 4% for purposes of this example. Thus, Tables 3, 4, and 5 show the depositor's portfolio during the third, fourth and fifth years, respectively, of the laddering strategy.

TABLE 3

| | | | Time Left | | |
|---|---|---|---|---|---|
| | | | Until | | |
| CD # | Principal | Term | Maturity | Rate | APY |
| 3 | $6,000 | 3 years | 1 year | 3% | 3% |
| 4 | $6,000 | 4 years | 2 years | 3.5% | 3.5% |
| 5 | $6,000 | 5 years | 3 years | 4% | 4% |
| 1 | $6,000 | 5 years | 4 years | 4% | 4% |
| 2 | $6,000 | 5 years | 5 years | 4% | 4% |

TABLE 4

| | | | Time Left | | |
|---|---|---|---|---|---|
| | | | Until | | |
| CD # | Principal | Term | Maturity | Rate | APY |
| 4 | $6,000 | 4 years | 1 year | 3.5% | 3.5% |
| 5 | $6,000 | 5 years | 2 years | 4% | 4% |
| 1 | $6,000 | 5 years | 3 years | 4% | 4% |
| 2 | $6,000 | 5 years | 4 years | 4% | 4% |
| 3 | $6,000 | 5 years | 5 years | 4% | 4% |

TABLE 5

| | | | Time Left | | |
|---|---|---|---|---|---|
| | | | Until | | |
| CD # | Principal | Term | Maturity | Rate | APY |
| 5 | $6,000 | 5 years | 1 year | 4% | 4% |
| 1 | $6,000 | 5 years | 2 years | 4% | 4% |
| 2 | $6,000 | 5 years | 3 years | 4% | 4% |
| 3 | $6,000 | 5 years | 4 years | 4% | 4% |
| 4 | $6,000 | 5 years | 5 years | 4% | 4% |

In the third, fourth and fifth years, the current period blended rates will be equal to 3.7%, 3.9% and 4%, respectively, and each year there will be $6,000 coming available.

The process of renewing each CD at maturity into another five year CD continues for as long as the depositor wishes to continue the laddering strategy, and as long as the strategy continues, the depositor will have $6,000 coming available each year and will be earning interest at the current period blended rate (based on the five CDs currently held within the portfolio) applicable each year. Thus, the laddering strategy allows the depositor to take advantage of the higher rates typically available for longer term CDs while still having a portion of principal available at shorter intervals of time. In addition, the customer has managed to reduce the interest rate risk of short and/or long term investing alone by always having funds invested in a variety of maturities.

As will be appreciated, it takes significant time and attention on the part of the participant to set-up, maintain, and monitor laddering strategies as described above. As noted above, when an asset matures it may automatically renew into the same type of asset having the same term, or some other previously disclosed term, or may even be placed in an even less advantageous account type, unless the participant monitors the activity of the portfolio and instructs the financial institution holding the asset otherwise. Thus, in the case of a CD laddering structure that was purchased all at one time, a depositor that wishes to establish and maintain a laddering strategy must watch when each CD in the portfolio matures and must take affirmative steps to renew each CD into a new CD having the appropriate term for the particular laddering strategy. If the depositor does nothing, the CD will be automatically renewed into a CD whose term will not maintain the desired laddering strategy. In addition, it takes significant time to establish the laddering strategy as purchasing each CD requires extensive paperwork on the part of the depositor. In the case of the example shown in Tables 1-5, five separate sets of paperwork must be completed by the depositor, one for each CD in the portfolio. For busy and/or unsophisticated depositors, the tasks required to establish and maintain a laddering strategy may prove to be too difficult and/or time consuming. In addition, because the individual components of the portfolio are not, as discussed above, linked to one another and represented as part of that portfolio, the effect of blended rates or other strategic combinations of asset types over time is not readily apparent, and the depositor may not fully realize the benefits of continuing the strategy.

The CD laddering example given above illustrates both the positive features of the component approach to financial products, but also identifies several shortcomings of individual selection of the component elements. What is lacking in the art, therefore, are unified financial asset products which automatically implement a predetermined strategy for purchasing, monitoring, selling, withdrawing and/or exchanging a plurality of linked component financial instruments according to that preset strategy, together with a methodology of implementation which provides periodic reporting of the status and/or performance of the product, so as to enhance the overall information that a depositor/investor possesses to make future financial decisions.

### SUMMARY OF THE INVENTION

The present invention relates to a financial asset product including a plurality of component instruments or products and a link among the components that interrelates the components as a unitary portfolio. The terms, or other return features of the deposit or investment components, to the extent such components are for a fixed term, are arranged according to a preset plan of the depositor/investor. The components may include bonds, certificates of deposit and/or other bank deposit products and the link among the components may be one or more pieces of linking data such as a common reference account number associated with each of the components. While CDs and bonds are specifically included as fixed term instruments, it should be noted by those skilled in the art that many other financial products and services may be included, as partially discussed herein.

The present invention also relates to a method of implementing a financial asset product. The method may include the steps of assessing the financial needs or goals of the depositor or investor, developing a predetermined or preset plan or strategy for the purchase, maintenance, sale, withdrawal and/or exchange of financial instruments or products, issuing or otherwise acquiring a plurality of component instruments or products, wherein each of the components is linked to one another to interrelate the components as a unitary instrument portfolio wherein the terms or other financial features of the components are arranged according to the preset plan. The method may further comprise the step of providing unitary reports relating to the unitary instrument portfolio. The unitary reports may include information relating to each of the components or information relating to the strategy implemented by the preset plan of the depositor or investor. Preferably, the linking step includes associating a common reference account number or common identifier with each of the components. In one embodiment, the components are all certificates of deposit. Other embodiments may include the combination of CDs, bonds, other deposit products such as savings accounts or other investment products. The CD components further include all embodiments of CDs having variable rates, repurchase and exchange options and the like.

The present invention also relates to a method of automatically maintaining a multi-component portfolio strategy for a depositor or investor. Specifically, one embodiment relates to a method of automatically maintaining a strategy of a depositor in a portfolio having Y fixed term instruments, such as CDs, wherein Y is at least two. Each of the fixed term instruments matures on a maturity date and one of the fixed term instruments matures every period X, such as one year. The method includes monitoring each of the fixed term instruments to determine when each of the fixed term instruments is about to mature, and sending, for each fixed term instrument about to mature, a notice to the depositor informing the depositor that the identified fixed term instrument will mature on its maturity date. The method further includes renewing the identified fixed term instrument, which is about to mature, into a new fixed term instrument having a term equal to YX, unless the depositor provides instructions to the contrary, i.e., not to so renew the identified fixed term instrument. In one embodiment, the method further comprises assigning a common reference account number to each of said Y fixed term instruments within a laddering strategy portfolio. In another embodiment, the notice may include an estimated next current period blended rate for the portfolio that estimates a next current period blended rate that will apply to the portfolio if the identified fixed term instrument is renewed into a new fixed term instrument having a term equal to YX. The notice may further include information relating to each of the Y fixed term instruments other than said identified fixed term instrument so as to provide valuable information for the depositor in making decisions regarding renewal. Preferably, the Y fixed term instruments initially have terms equal to X, 2X . . . YX. According to alternate embodiments of the method, new fixed term instruments may be added to the portfolio while at the same time maintaining the strategy.

The present invention also relates to a financial product including Y fixed term instruments, wherein Y is at least two, wherein one of the Y fixed term instruments matures every period X, and wherein each of the Y fixed term instruments automatically renews into a fixed term instrument having a term equal to YX when it matures unless instructions not to do so are given by the depositor holding the product. The fixed term instruments may be certificates of deposit, and may be linked by a reference account number. Each of the fixed term instruments may also have an APY that is higher than an APY offered for CDs of like terms and amounts when purchased individually.

In an alternate embodiment, the present invention relates to a financial product and method for creating that product by implementing and automatically maintaining a laddering strategy in a portfolio having B fixed term instruments wherein the fixed term instruments mature at a common maturity date. Specifically, at a first time point in the strategy, typically at initiation, each of the B fixed term instruments mature on a given maturity date such that at the first time point, each of the fixed term instruments will mature every period XB. During the pendency of this collapsing ladder strategy, each component fixed term instrument is replaced, at the given maturity date, with an appropriate fixed term instrument having a calculated maturity date such that, at a second time point, typically at the conclusion point of the strategy, all of the B fixed term instruments now present in the portfolio will mature on a common maturity date. The method includes monitoring each of the fixed term instruments to determine when each of the fixed term instruments is about to mature, sending, for each fixed term instrument about to mature, a notice to the depositor prior to the first maturity date of the fixed term instrument about to mature, which informs the depositor that the fixed term instrument about to mature will mature on the first maturity date of the fixed term instrument about to mature, and renewing the fixed term instrument about to mature into a fixed term instrument having a term equal to the difference between BX and the first term of the fixed term instrument about to mature unless (i) the depositor provides instructions not to so renew the fixed term instrument about to mature or (ii) the fixed term instrument about to mature has a first term equal to BX. Information about the new effect of blending the component instruments is also provided to help the investor with the decision making process In yet another embodiment, the present invention relates to a financial product and method of creation and implementation wherein the purchase of the portfolio components are completed over a preset time period according to a preset interval strategy. In this embodiment, a portfolio of B fixed term instruments are purchased having common maturity terms X, but at intervals Z, such that after a period of time equal to B−1, the customer has purchased B fixed term instruments having maturity dates separated by ZX intervals.

These and other objectives, features and advantages of the present invention will be more readily understood upon consideration of the following detailed description of the preferred embodiments and the accompanying drawings.

### BRIEF DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 is a block diagram illustrating a financial product according to one embodiment of the present invention;

FIG. 2 is a flow diagram illustrating a first embodiment of a financial product and a method for implementing the product that establishes and automatically maintains a laddering strategy according to the present invention;

FIG. 3 is a flow diagram illustrating a second embodiment of a financial product and a method for implementing the product that establishes and automatically maintains a laddering strategy according to the present invention;

FIG. 4 is a flow diagram illustrating a third embodiment of a financial product and a method for implementing the product that establishes and automatically maintains a laddering strategy according to the present invention; and

FIG. 5 is a flow diagram illustrating a fourth embodiment of a financial product and a method for implementing the product that establishes and automatically maintains a strategy according to the present invention in which multiple fixed term instruments mature at a common maturity date.

### DETAILED DESCRIPTION OF THE PREFERRED EMBODIMENTS

In one embodiment, the present invention relates to a financial deposit product that includes multiple fixed term instruments, such as CDs or other bank deposits, having a variety of terms. Each of the fixed term instruments are interrelated or linked to one another such that they together form a unitary instrument portfolio. In the portfolio, the terms of the individual fixed term instruments are chosen and arranged according to a preset plan in order to implement a strategy of the depositor, such as, for example, a laddering strategy. Preferably, a link in the form of one or more pieces of common administrative linking data such as a common reference account number or the like is assigned to the unitary instrument portfolio and associated with each of the fixed term instruments for purposes of interrelating and linking all of the fixed term instruments to one another. The link is advantageous in that it enables the multiple fixed term instruments to be readily identified as being part of the unitary instrument portfolio and therefore enables the issuing bank to generate and issue unitary reports for the portfolio including information relating to each of the fixed term instruments in the portfolio, the portfolio as a whole and/or the strategy that the portfolio implements. For example, if the portfolio implements a CD laddering strategy, the link would enable the bank to provide unitary reporting for the portfolio of information such as the term, account number, maturity date, APY and balance of each CD in the portfolio, the current period blended rate for the portfolio for any soon to be ending liquidity period, and information relating to the next current period blended rate that would result for the portfolio if the depositor extends the laddering strategy.

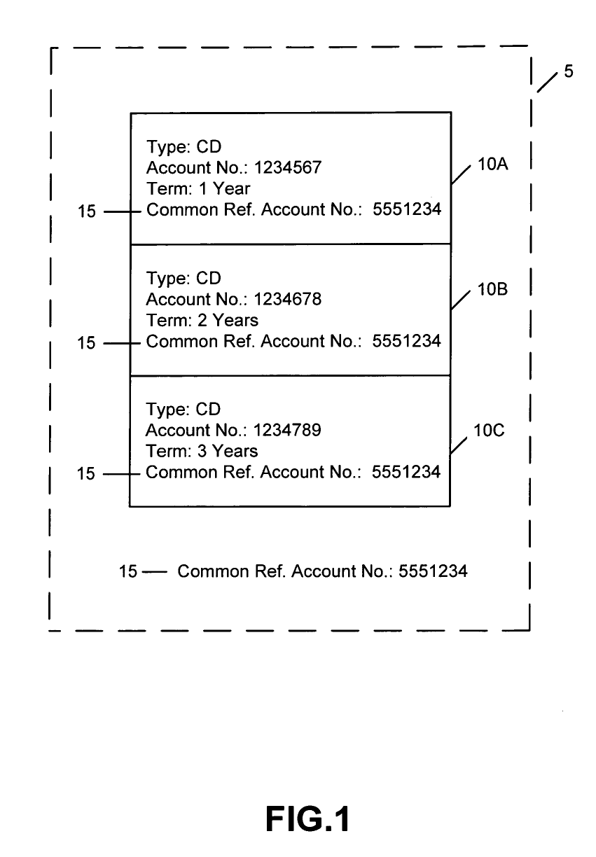

FIG. 1 is a block diagram that illustrates an example of such a financial asset product. As shown in FIG. 1, financial asset product 5 includes fixed term instrument 10A, which is a one year CD having account number 1234567, fixed term instrument 10B, which is a two year CD having account number 1234678, and fixed term instrument 10C, which is a three year CD having account number 1234789. As seen in FIG. 1, financial asset product 5 and each of fixed term instruments 10A, 10B and 10C have associated therewith common reference account number 15, which in this example is 5551234.

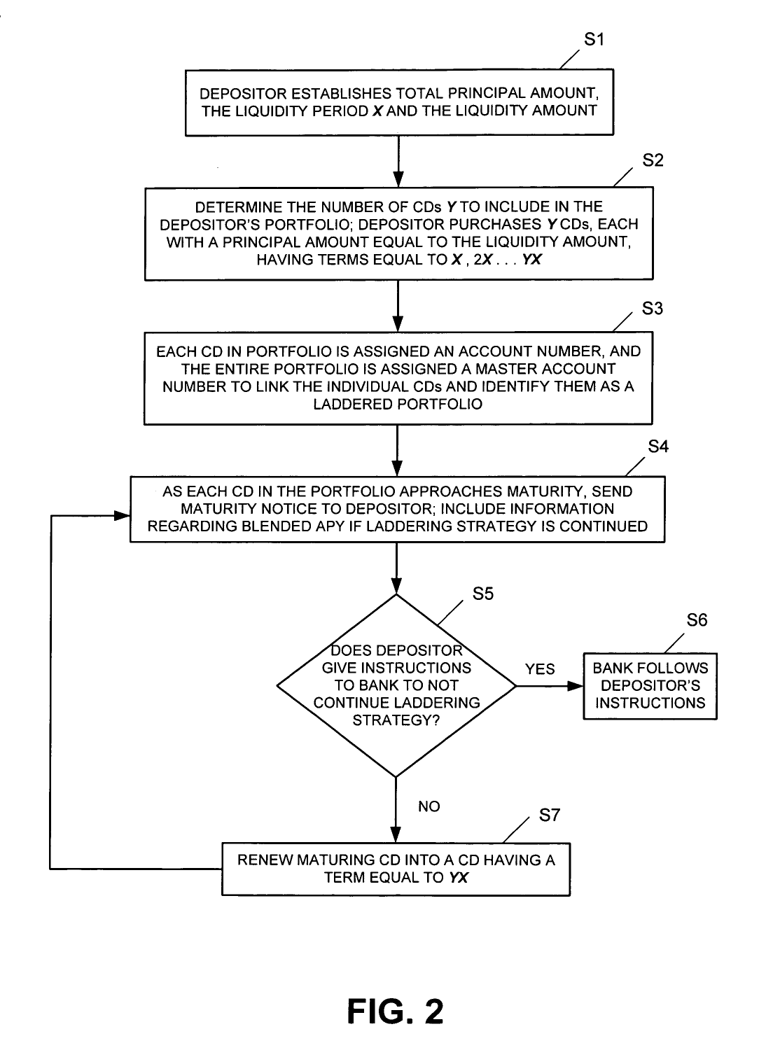

According to another embodiment, the present invention relates to a financial asset product and a method for implementing the product that establishes and automatically maintains a laddering strategy that continues over time for a depositor. FIG. 2 is a flow diagram illustrating a first embodiment of the financial asset product and the method according to the present invention. Referring to step S1, a depositor interested in establishing a laddering strategy contacts the financial institution and establishes certain parameters relating to the desired laddering strategy, including the types of instruments or components to be included in the financial asset product, the total principal amount to be utilized to fund the product, the time period for such finding, any liquidity period X and a liquidity amount, as necessary. Also determined will be the reporting, managing and monitoring parameters for the financial institution. This strategy may be developed in conjunction with financial advisors or bank personnel who will provide the various parametric options and the rationale for selecting such options. The preset plan or strategy may include such parameters as: frequency of financial need, time to liquidity, funding amount, anticipated rate of growth, rate of liquidation, intermediate liquidity and additional planned contributions to the product.

In this particular preferred embodiment, a series of CDs are utilized to form the portfolio in conjunction with a bank. In step S2, the number of CDs Y to include in the depositor's portfolio to implement the desired laddering strategy is determined. The number of CDs Y is determined by dividing the total principal amount to be deposited by the liquidity amount. This may be an iterative process whereby the depositor makes decisions relating to liquidity amounts based on easy to use tools produced by the Bank. Then, the depositor purchases Y CDs for the portfolio. The Y CDs each have a principal amount equal to the liquidity amount and have staggered terms equal to X, 2X . . . YX. According to one embodiment, the CDs will have APYs equal to the then current APYs offered by the bank for CDs of like terms and amounts when purchased individually. In an alternate embodiment, the CDs that are to become a part of the financial deposit product of the present invention have APYs that are higher than those generally available for similar CDs purchased individually, such as by 0.25%-0.50%. As a specific example, if the depositor has $30,000 to deposit and wants to have $6,000 come available each year, the liquidity period X will be one year and the liquidity amount will be $6,000. Thus, in step S2, the portfolio will be established with five $6,000 CDs having terms of one year, two years, three years, four years and five years. Referring to step S3, each CD in the portfolio is assigned an account number, and all of the CDs are together assigned a common reference account number. As described above, assigning a common reference account number to all of the CDs in the portfolio links the CDs together and allows the bank to readily recognize that the depositor holding the CDs is utilizing a laddering strategy. As a result, with this knowledge, the bank can provide the depositor with better data to make informed decisions throughout the life of the depositor's strategy. This is in contrast to prior art laddering strategies where each CD within a laddered portfolio is treated as a separate instrument with no relationship to the other CDs in the laddered portfolio other than in the depositor's mind. In other words, in the prior art, even when the bank may have known at inception that a laddering strategy was being implemented buy a depositor, the bank maintains no ongoing understanding that certain CDs are part of a laddered portfolio, and the onus for maintaining a particular laddering strategy rests entirely with the depositor. According to a preferred embodiment of the present invention, the process for purchasing the CDs in the portfolio is greatly simplified by only providing the depositor with one set of documentation, including required disclosures and certificates, covering all of the CDs to be included in the portfolio and also including information related to current period blended rate for all CDs included in the portfolio. This is in contrast to the prior art which requires that separate documentation be provided to and reviewed by the depositor for each CD forming a part of a laddering strategy. In addition, the depositor will be informed of their new portfolio's Composite APY, which reflects the APY of the entire component portfolio, calculated according to the appropriate guidelines therefor.

Next, at step S4, as each CD in the portfolio established in step S2 approaches maturity, a maturity notice is sent to the depositor. The maturity notice will state that, unless the depositor provides other instructions within a specified time period, such as within seven days of the maturity date, the bank will automatically renew the CD into a CD having an appropriate term for extending the laddering strategy, specifically a term equal to YX, which is the longest term in the portfolio established in step S2. In the example provided above, the term of the renewed CD will be five years. The renewed CD will, in one embodiment, have a principal amount equal to the liquidity amount, in which case the interest earned on the CD up until renewal is paid out to the depositor. In an alternate embodiment, the interest earned on the maturing CD is rolled into the renewed CD so that the renewed CD will have a principal amount equal to the liquidity amount plus the earned interest. In another embodiment, the renewed CD can have a principle amount equal to the liquidity amount plus an additional deposit amount that the depositor can contribute at renewal time. The maturity notice sent to the depositor in step S4 may also include the current period blended rate for the portfolio for the just ending liquidity period, the term, maturity date and maturity value of the maturing CD, the common reference account number, information relating to the other CDs in the portfolio linked by the common reference account number, such as the account numbers, terms, maturity dates, APYs and current balances, and, preferably, information relating to the next current period blended rate that will result for the portfolio if the depositor extends the laddering strategy. This current period blended rate will be based on the current rate for the CD to be renewed, with a reference to the actual rate at maturity not being known at that time. At step S5, a determination is made as to whether the depositor, in response to the maturity notice, gave the bank instructions to do something other than continue the established laddering strategy, such as instructions to not renew the CD and pay out the principal or to renew the CD into another CD having a term that would not continue the laddering strategy. If the answer at step S5 is yes, then, at step S6, the bank will follow the depositor's instructions, and the closed CD or alternatively renewed CD is no longer part of the ladder portfolio. The other CDs in the original ladder portfolio will continue to be subject to the method shown in FIG. 2. If the answer in step S5 is no, then, at step S7, the bank automatically renews the maturing CD into a CD having a term equal to YX, which is the term of the CD having the longest term in the portfolio established in step S2. Step S7 will thus extend the laddering strategy to ensure that one CD will mature each liquidity period and the liquidity amount or more, depending on whether the inventor elects to roll interest into renewals, will come available to the depositor at the end of each liquidity period. Step S7 is contrary to the prior art, wherein, if the depositor lets a CD in a laddered portfolio automatically renew, the laddering strategy will break down because the renewed CD will not have a term appropriate for continuing the laddering strategy (the term will be equal to the original term of the CD). In the prior art, if the depositor wants to continue the laddering strategy, the depositor must take affirmative steps to not renew the CD and must purchase a new CD having an appropriate term which may require new account numbers, terms/conditions, and disclosures. Next, the method returns to step S4 and the bank waits for the next CD in the portfolio to approach maturity. The method thus continues indefinitely until the depositor gives instructions, in step S5, that would cause the laddering strategy to be discontinued.

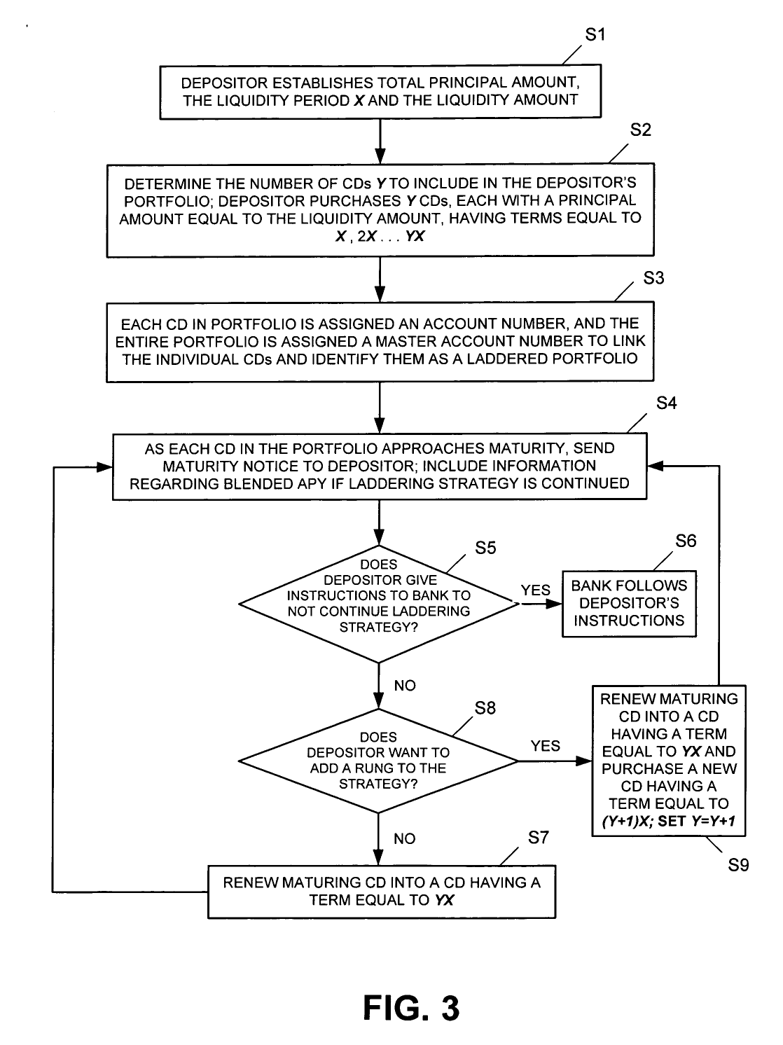

According to an alternate embodiment of the present invention, the depositor is given the option to add a “rung” to the laddering strategy as each CD in the portfolio matures so that the portfolio, which originally had Y CDs having terms of X, 2X . . . YX, will now have Y+1 CDs having terms of X, 2X . . . YX and (Y+1)X. The liquidity period X will stay the same. The advantage of adding a rung, i.e., another CD, to a laddering strategy is that, in most cases, the current period blended rate will be higher because CD Y+1, having a term of (Y+1)X, is likely to have a higher rate/APY than the other CDs in the portfolio. FIG. 3 is a flow diagram illustrating this alternate embodiment of the present invention. Steps S1 through S7 are the same as described in FIG. 2. In this embodiment, however, if the answer to step S5 is no, at step S8 a determination is made as to whether the depositor wants to add a rung, i.e., another CD, to the laddering strategy. If the answer in step S8 is no, then the method proceeds to step S7 as described in FIG. 2 wherein the established laddering strategy is automatically continued by renewing the maturing CD into an appropriate YX term CD. If, however, the answer in step S8 is yes, then, at step S9, the maturing CD is renewed into a CD having a term equal to YX and a new CD is purchased having a term equal to (Y+1)X. This new CD may have a principal amount equal to the liquidity amount to be consistent with the other CDs in the portfolio. The new CD is linked with the common reference account number established in step S3 so that it will thereafter be identified as being a part of a laddering strategy. In addition, Y is set equal to Y+1 so that in step S7, after a rung is added, the method will automatically maintain the laddering strategy by renewing maturing CDs into CDs having terms of appropriate lengths. The method then proceeds to step S4 and the bank waits for the next CD to mature. It will be appreciated that more than one rung, i.e., more than one CD, can be added in steps S8 and S9.

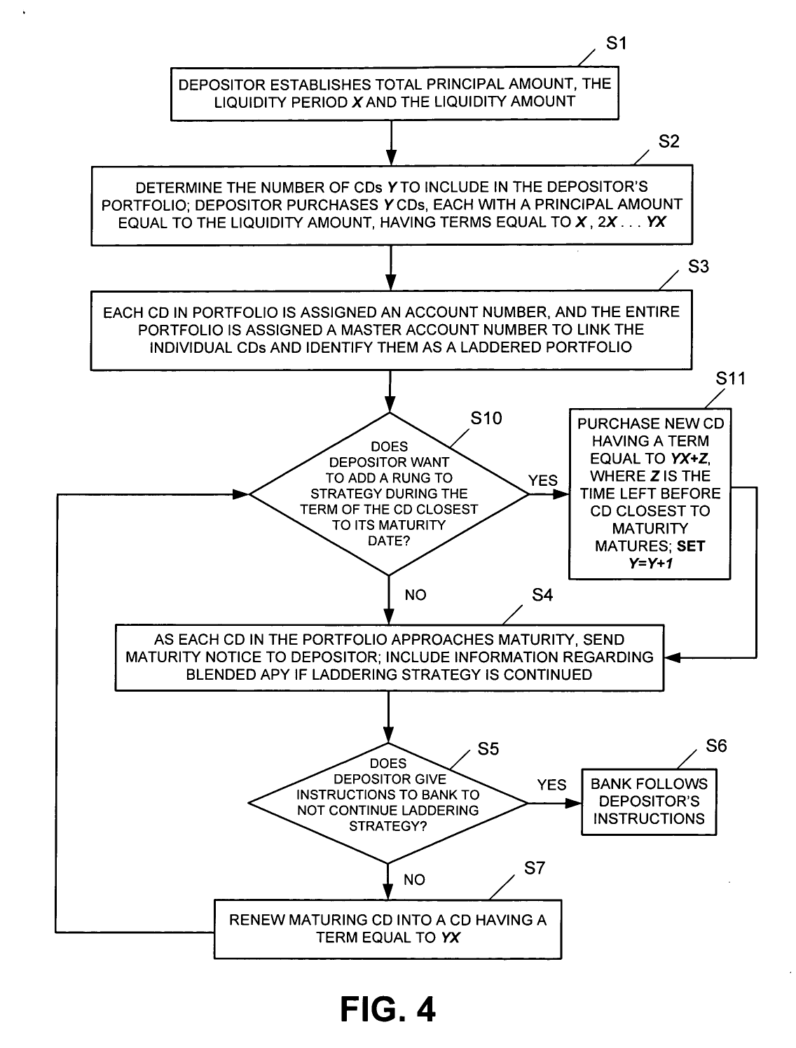

According to a further alternate embodiment of the present invention shown in FIG. 4, the depositor is able to add a rung to the laddering strategy at anytime, such as during the term of the CD in the portfolio that is closest to maturity. In other words, in contrast to the embodiment of FIG. 3 where rungs may be added as CDs mature, in the embodiment shown in FIG. 4 the depositor does not need to wait until that point, and instead may add a rung at anytime. As was the case in FIG. 3, in the embodiment shown in FIG. 4, the new portfolio will have Y+1 CDs each maturing at intervals equal to the liquidity period. Steps S1 through S7 are the same as described in connection with FIG. 2. In this embodiment, new step S10 is added after step S3 in which a determination is made as to whether the depositor wants to add a rung to the laddering strategy. If the answer is no, then the method proceeds to steps S4 through S7 as described in FIG. 2. If the answer in step S10 is yes, then, at new step S11, a new CD is purchased having a term equal to YX+Z, where Z is the time left before the CD closest to maturity actually matures. The value of Y is then changed to Y+1, as there will now by Y+1 CDs in the portfolio. The method then proceeds to steps S4 through S7. The following example illustrates the embodiment of the present invention shown in FIG. 4. Assume that the depositor initially establishes, in steps S1 through S3, a laddering portfolio having three $6,000 CDs each having a term of one year. The portfolio will thus be as shown in Table 6 below.

TABLE 6

| | | | Time Left | | |
|---|---|---|---|---|---|
| | | | Until | | |
| CD #1 | Principal | Term | Maturity | Rate | APY |
| 1 | $6,000 | 1 year | 1 year | 1.5% | 1.5% |
| 2 | $6,000 | 2 years | 2 years | 2% | 2% |
| 3 | $6,000 | 3 years | 3 years | 3% | 3% |

If the depositor wants to add another rung to the laddering strategy three months into the term of CD #1, according to the embodiment shown in FIG. 4, the depositor will purchase a new $6,000 CD (in this example, the principal amount of the new CD is $6,000, but it should be noted that the principal amount can be any amount the depositor chooses) having a term equal to 45 months (YX+Z=36 mo.+9 mo.). The depositor's portfolio will thus be as shown in Table 7 below.

TABLE 7

| | | | Time Left | | |
|---|---|---|---|---|---|
| | | | Until | | |
| CD #1 | Principal | Term | Maturity | Rate | APY |
| 1 | $6,000 | 1 year | 9 mo. | 1.5% | 1.5% |
| 2 | $6,000 | 2 years | 21 mo. | 2% | 2% |
| 3 | $6,000 | 3 years | 33 mo. | 3% | 3% |
| 4 | $6,000 | 45 months | 45 mo. | 3.25% | 3.25% |

Then, as CD #1 matures, unless the depositor gives the bank contrary instructions, CD #1 will be automatically renewed into a $6,000 four year CD to extend the laddering strategy as modified in steps 10 and 11. The depositor's portfolio will thus be as shown in Table 8 below.

TABLE 7

| | | | Time Left | | |
|---|---|---|---|---|---|
| | | | Until | | |
| CD #1 | Principal | Term | Maturity | Rate | APY |
| 2 | $6,000 | 2 years | 12 mo. | 2% | 2% |
| 3 | $6,000 | 3 years | 24 mo. | 3% | 3% |
| 4 | $6,000 | 45 months | 36 mo. | 3.25% | 3.25% |
| 1 | $6,000 | 4 years | 48 mo. | 3.5% | 3.5% |

Thus, as will be appreciated, the depositor now has a laddering strategy consisting of four CDs with a liquidity period of one year and a liquidity amount of $6,000. The current period blended rate for this strategy at the point shown in Table 8 is approximately 2.94%.

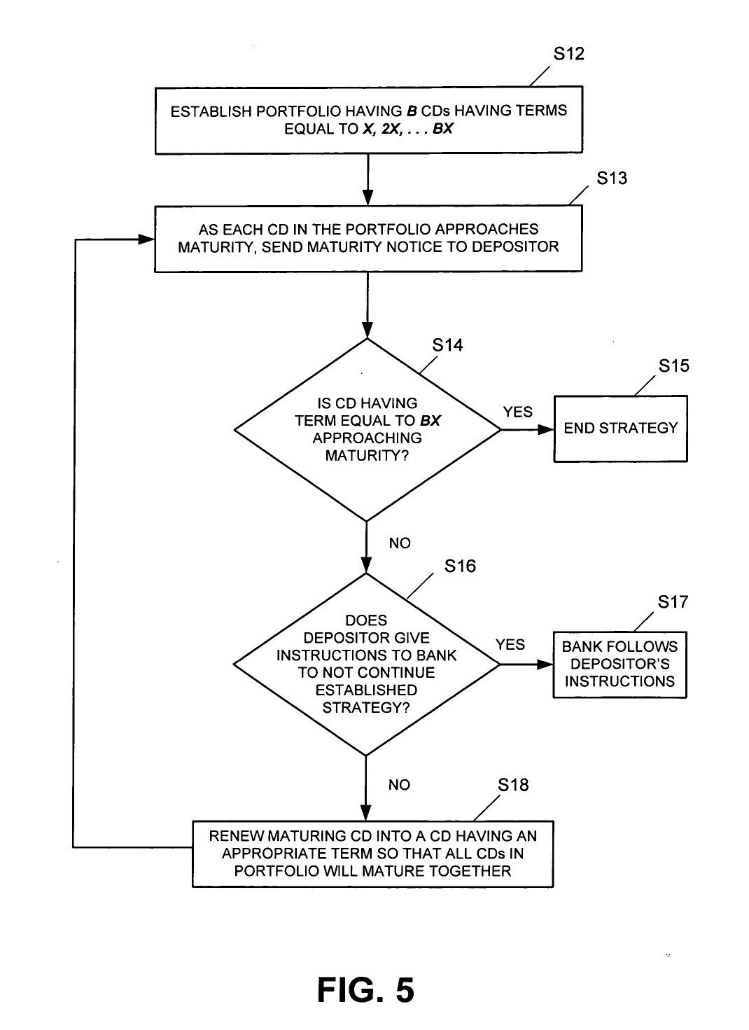

In an alternative embodiment of the present invention, a strategy is implemented and automatically maintained in which a depositor can establish a portfolio consisting of a plurality of CDs having a liquidity period X as described above wherein the depositor can specify that all of the CDs are to mature at the same time in the future after some fixed period A has elapsed (A and X are expressed in the same time denominations, e.g., years or months). For example, a depositor may want all of his or her CDs to mature at the end of five years. Referring to FIG. 5, according to this aspect of the present invention, the portfolio is established at step S12 with B CDs having terms equal to X, 2X, . . . BX, wherein X is the liquidity period and B is equal to A÷X. For example, if A is equal to five years, and the liquidity period is one year, in step S12 the portfolio will be established with five CDs (5÷1=5) having terms equal to one year, two years, three years, four years and five years. In this example, it is the depositors desire to have all of the CDs mature together at the end of five years. Steps S13 through S18 of FIG. 5 illustrate a method for accomplishing this goal. At step S13, as each CD in the portfolio approaches maturity, a maturity notice is sent to the depositor that, among other things, indicates that unless the depositor gives contrary instructions, the CD will be automatically renewed into a CD having an appropriate term (as described below) to enable the whole portfolio to mature at the end of the time period A. Next, at step S14, a determination is made as to whether the CD in the portfolio that has a term equal to BX is the one that is approaching maturity. As will be appreciated, this is done to determine whether the end of time period A is approaching (the time period A ends when the term BX ends; A=BX), meaning the strategy is coming to an end (step S15). If the answer in step S14 is no (meaning that it is not the end of the strategy according to this aspect of the present invention), then a determination is made at step S116 as to whether the depositor has given instructions not to continue the established strategy. If the answer is yes, then at step S17, the bank follows those instructions. If the answer is no, then at step S18, the maturing CD is renewed into a CD having an appropriate term so that all of the CDs in the portfolio will mature together at the end of the time period A. The appropriate term to accomplish this goal for each CD is equal to the difference between (1) BX and (2) the term of the maturing CD (e.g., X, 2X . . . ). After each CD is so renewed (except for the CD having a term equal to BX), the method returns to step S13 and continues until the BX term CD matures, which marks the end of the time period A and the end of the strategy. In the example being used herein consisting of five CDs having terms ranging from one to five years, when the one year CD matures, it is renewed into a four year CD (5−1=4), when the two year CD matures, it is renewed into a three year CD (5−2=3), when the three year CD matures, it is renewed into a two year CD (5−3=2), and when the four year CD matures, it is renewed into a one year CD (5−4=1). In this example, all of the CDs in the portfolio will mature together at the end of five years. By utilizing the method shown in FIG. 5, a bank would maintain a diverse portfolio at the depositor's request, thereby helping to mitigate any interest rate/liquidity risk, while being able to have all of the instruments mature on one day.

It will be appreciated that the method shown in FIG. 5 may be utilized at the beginning of a strategy established by a depositor such that step S12 involves the depositor newly purchasing the CDs for the portfolio. It will also be appreciated that the same method may be utilized by a depositor after the depositor has used the methods shown in FIGS. 2, 3 and/or 4 for a period of time to establish and maintain a laddering strategy. For example, the method of FIG. 5 may be used after a laddering strategy has been established and maintained using the methods shown in FIGS. 2, 3 and/or 4 for a period of time such that the portfolio has the form shown in Table 5. As seen in Table 5, the portfolio at that point has five CDs which have times left until maturity equal to one year, two years, three years, four years and five years. The portfolio in that state is similar to the portfolio that would be established in step S12 of FIG. 5 (i.e., a portfolio of five CDs having terms of one year, two years, three years, four years and five years). Steps S13 through S18 could then be utilized in connection with the portfolio of Table 5 to implement a strategy wherein all of the CDs in the portfolio will mature together at the same time (i.e., at the end of five years).

The terms and expressions which have been employed herein are used as terms of description and not as limitation, and there is no intention in the use of such terms and expressions of excluding equivalents of the features shown and described or portions thereof, it being recognized that various modifications are possible within the scope of the invention claimed. Although particular embodiments of the present invention have been illustrated in the foregoing detailed description, it is to be further understood that the present invention is not to be limited to just the embodiments disclosed, but that they are capable of numerous rearrangements, modifications and substitutions. For example, although several examples have been provided herein utilizing CDs as the instrument making up the portfolio, it will be appreciated that other types of fixed term instruments such as bonds as well as liquid deposit instruments such as checking and savings accounts may be used in the present invention.

1. A component financial asset product, comprising:
a plurality of financial asset instruments; and
a link among said financial asset instruments that interrelates said financial asset instruments as a unitary instrument portfolio wherein said linked instruments are selected, managed and sold according to a preset plan.

2. A financial asset product according to claim 1, wherein said financial asset instruments are selected from the group consisting of deposit instruments and investment instruments.

3. A financial asset product according to claim 2, wherein said deposit instruments are selected from the group consisting of certificates of deposit, checking and savings accounts.

4. A financial asset product according to claim 2, wherein said investment instruments are bonds.

5. A financial asset product according to claim 1, wherein said component financial asset instruments are selected from the group consisting of fixed term instruments and demand accounts.

6. A financial asset product according to claim 1, said link comprising administrative data common to each of said financial asset instruments.

7. A financial asset product according to claim 6, said administrative data comprising a common reference account number.

8. A financial asset product according to claim 1, wherein the management of said linked instruments further comprises reporting of interim composite status and performance of the linked instruments.

9. A financial asset product according to claim 1, wherein the management of said linked instruments further comprises optional changes to one of the components and the parameters of the components after initiation of the product.

10. A financial asset product according to claim 1, wherein the management of said linked instruments further comprises optional changes to one of the number and type of the components after initiation of the product.

11. A financial asset product according to claim 1, wherein the preset plan relating to said linked instruments is based upon the parameters of the components and the individual needs of the purchaser.

12. A financial asset product according to claim 11, wherein the preset plan relating to said linked instruments is based upon parameters selected from the group consisting of: frequency of financial need, time to liquidity, funding amount, anticipated rate of growth, rate of liquidation, intermediate liquidity and additional planned contributions to the product.

13. A method of implementing a financial asset product, comprising:
obtaining a plurality of financial asset instruments; and
linking each of said financial asset instruments to one another to interrelate said financial asset instruments as a unitary instrument portfolio wherein funding of said linked instruments is selected, managed and withdrawn according to a preset plan.

14. A method according to claim 13, further comprising establishing at least one account which comprises at least one of said financial asset instruments.

15. A method according to claim 13, further comprising providing unitary reports relating to said unitary instrument portfolio.

16. A method according to claim 15, said unitary reports including information relating to each of said financial asset instruments.

17 to claim 15, said unitary reports including information relating to a strategy implemented by said preset plan.

18. A method according to claim 15, said unitary reports including information relating to the maturity of at least one component of the portfolio.

19. A method according to claim 15, wherein said unitary reports are presented in at least one of tangible and electronic forms.

20. A method according to claim 13, further comprising the step of establishing a blended return rate for the portfolio.

21. A method according to claim 13, wherein said financial asset instruments are selected from the group consisting of deposit instruments and investment instruments.

22. A method according to claim 21, wherein said deposit instruments are selected from the group consisting of certificates of deposit, checking and savings accounts.

23. A method according to claim 21, wherein said investment instruments are bonds.

24. A method according to claim 13, wherein said component financial asset instruments are selected from the group consisting of fixed term instruments and demand accounts.

25. A method according to claim 13, said link comprising administrative data common to each of said financial asset instruments.

26. A method according to claim 25, said administrative data comprising a common reference account number.

27. A method according to claim 15, wherein the unitary reports comprise reporting of interim composite status and performance of the linked instruments.

28. A method according to claim 13, further comprising the step of changing at least one of the components and the parameters of the components after initiation of the product.

29. A method according to claim 13, further comprising the step of changing at least one of the number and type of the components after initiation of the product.

30. A method according to claim 13, wherein the preset plan relating to said linked instruments is based upon the parameters of the components and the individual needs of the purchaser.

31. A method according to claim 30, wherein the preset plan relating to said linked instruments is based upon parameters selected from the group consisting of: frequency of financial need, time to liquidity, funding amount, anticipated rate of growth, rate of liquidation, intermediate liquidity and additional planned contributions to the product.

32. A method of automatically maintaining a strategy of a depositor in a portfolio having Y fixed term instruments, wherein Y is at least two, each of said fixed term instruments maturing on a maturity date, wherein one of said Y fixed term instruments matures every period X, the method comprising:
monitoring each of said fixed term instruments to determine when each of said fixed term instruments is about to mature;
sending, for each fixed term instrument about to mature, a notice to said depositor prior to the maturity date of said fixed term instrument about to mature, said notice informing the depositor that said fixed term instrument about to mature will mature on the maturity date of said fixed term instrument about to mature; and
renewing said fixed term instrument about to mature into a fixed term instrument having a term equal to YX after the fixed term instrument about to mature actually matures unless the depositor provides instructions not to so renew said fixed term instrument about to mature.

33. A method according to claim 32, said fixed term instruments being certificates of deposit.

34. A method according to claim 32, further comprising assigning a common reference account number to each of said Y fixed term instruments.

35. A method according to claim 32, said notice including an estimated current period blended rate for said portfolio, said estimated current period blended rate estimating a current period blended rate that will apply to said portfolio if said fixed term instrument about to mature is renewed into a fixed term instrument having a term equal to YX.

36. A method according to claim 35, said notice further including information relating to each of said Y fixed term instruments other than said fixed term instrument about to mature.

37. A method according to claim 32, wherein prior to said renewing step being performed for the first time said Y fixed term instruments have terms equal to X, 2X . . . YX.

38. A method according to claim 32, further comprising the following steps after said sending step and before said renewing step: determining whether said depositor wants to add a new fixed term instrument to said portfolio, and if so, (i) adding said fixed term instrument to said portfolio, said new fixed term instrument having a term equal to (Y+1)X, and (ii) thereafter setting Y equal to Y+1 for each time said renewing step is performed in the future.

39. A method according to claim 32, further comprising the following steps prior to said sending step: determining whether said depositor wants to add a new fixed term instrument to said portfolio, said new fixed term instrument being purchased by said depositor, and, if so, (i) adding said new fixed term instrument to said portfolio, said new fixed term instrument having a term equal to YX+Z, wherein Z is an amount of time left before the fixed term instrument in said portfolio currently closest to maturity actually matures, and (ii) thereafter setting Y=Y+1 for each time said renewing step is performed in the future.

40. A method according to claim 32, further comprising establishing said portfolio, wherein each of said fixed term instruments has an APY that is higher than an APY offered for CDs of like terms and amounts when purchased individually.

41. A method according to claim 32, wherein in said renewing step said fixed term instrument having a term equal to YX has a principal amount equal to a principal amount of said fixed term instrument about to mature.

42. A method according to claim 33, wherein in said renewing step said fixed term instrument having a term equal to YX has a principal amount equal to a principal amount of said fixed term instrument about to mature plus at least a portion of an interest amount earned by said fixed term instrument about to mature.

43. A financial asset product, comprising Y fixed term instruments, wherein Y is at least two, wherein one of said Y fixed term instruments matures every period X, and wherein each of said Y fixed term instruments automatically renews into a fixed term instrument having a term equal to YX when it matures unless instructions not to do so are given by a depositor holding said financial asset product.

44. A financial asset according to claim 43, said fixed term instruments being certificates of deposit.

45. A financial asset product according to claim 43, said fixed term instruments being linked by a common reference account number.

46. A financial asset product according to claim 43, wherein each of said fixed term instruments has an APY that is higher than an APY offered for CDs of like terms and amounts when purchased individually.

47. A method of automatically maintaining a strategy of a depositor in a portfolio having B fixed term instruments, wherein B is at least two, wherein at a first point in said strategy each of said fixed term instruments have a first term and mature on a first maturity date such that at said first point one of said fixed term instruments will mature every period X, and wherein at a second point in said strategy all of said fixed term instruments will mature on a common maturity date, the method comprising:
monitoring each of said fixed term instruments to determine when each of said fixed term instruments is about to mature;
sending, for each fixed term instrument about to mature, a notice to said depositor prior to said first maturity date of said fixed term instrument about to mature, said notice informing the depositor that said fixed term instrument about to mature will mature on said first maturity date of said fixed term instrument about to mature; and
renewing said fixed term instrument about to mature into a fixed term instrument having a term equal to the difference between BX and the first term of said fixed term instrument about to mature unless (i) the depositor provides instructions not to so renew said fixed term instrument about to mature or (ii) said fixed term instrument about to mature has a first term equal to BX.

48. A method according to claim 47, said fixed term instruments being certificates of deposit.

49. A method according to claim 47, further comprising assigning a common reference account number to each of said fixed term instruments.

50. A financial asset product for implementing a strategy over a period of time, comprising B fixed term instruments, wherein B is at least two, wherein at a first point in said period of time each of said fixed term instruments have a first term and mature on a first maturity date such that at said first point one of said fixed term instruments will mature every period X, wherein at a second point in said period of time all of said fixed term instruments will mature on a common maturity date, and wherein between said first point and said second point each of said B fixed term instruments, except for a selected one of said fixed term instruments having a term equal to BX, automatically renews when it matures into a fixed term instrument having a term equal to the difference between BX and the first term of said fixed term instrument unless instructions not to do so are given by a depositor holding said financial deposit product.

51. A financial asset product according to claim 50, said fixed term instruments being certificates of deposit.

52. A financial deposit product according to claim 50, said fixed term instruments being linked by a common reference account number.
